(19) United States
(12) Patent Application Publication
(10) Pub. No.: US 2014/0258850 A1
(43) Pub. Date: Sep. 11, 2014

(54) Systems and Methods for Managing the Display of Images

(71) Applicant: Mathew R. Carey, Chicago, IL (US)

(72) Inventor: Matthew R. Carey, Chicago, IL (US)

(73) Assignee: Mathew R. Carey, Chicago, IL (US)

(21) Appl. No.: 14/204,964

(22) Filed: Mar. 11, 2014

Related U.S. Application Data
(60) Provisional application No. 61/776,761, filed on Mar. 11, 2013.

(51) Int. Cl. G06F 3/0484

(52) U.S. Cl. CPC G06F 3/0484
USPC 715/243

(57) ABSTRACT

Methods and systems for updating a user interface with images having common attributes or parameters. According to aspects, a user of a social networking application may be connected to multiple other users of the application. The multiple other users may upload respective images to a server for viewing by the user via the social networking application. The systems and methods examine the multiple images identify a location object or event that is common to two or more of the multiple images. An electronic device of the user is configured to present the image having common location objects or events in a common area of a user interface. Further, the electronic device is configured to dynamically update the user interface in response to receiving additional images having the common location object or event.

### CROSS-REFERENCE TO RELATED APPLICATIONS

This application claims the benefit of U.S. Provisional Application No. 61/776,761, filed Mar. 11, 2013, which is incorporated by reference herein.

### FIELD

This application generally relates to image management. In particular, the application relates to platforms and techniques for consolidating the display of images based on associated metadata.

### BACKGROUND

Existing applications are capable of displaying images in a social networking “feed” whereby the images are presented according to a temporal aspect. For example, in a given feed of a user, the most recent image is displayed first (or last), and older images are displayed after (or before) the most recent image. However, the existing application do not present images based on certain shared attributes of the images. Additionally, the existing applications do not update feeds in response to new image uploads having shared attributes with existing images.

Accordingly, there is an opportunity for consolidating images and updating image presentation within a common area of a user interface based on shared attributes.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 illustrates an example environment including various components for facilitating image display in accordance with some embodiments.

FIG. 2 depicts a flow chart diagram for facilitating image display in accordance with some embodiments.

FIGS. 3A-3F depict example interfaces of a device in accordance with some embodiments.

FIGS. 4A-4B depict example interfaces of a device in accordance with some embodiments.

FIGS. 5A-5B depict example interfaces of a device in accordance with some embodiments.

FIG. 6 is an example chart in accordance with some embodiments.

FIG. 7 is a block diagram of a computer system in accordance with some embodiments.

FIG. 8 is a block diagram of an electronic device in accordance with some embodiments.

### DETAILED DESCRIPTION

The novel systems and methods disclosed herein relate generally to managing the display of images in a social networking feed. In existing applications, a user are able to upload images which are then shared with other users that are part of the user's social network (i.e., are “connected” to or “following” the user). The user can also view the images that are uploaded by the user's social network. In these existing applications, the images are presented in a temporal fashion, whereby the most recent image is displayed first (or last), and older images are displayed after (or before) the most recent image. Additionally, the applications do not consolidate images from multiple users in a common area of the feed based on certain shared attributes of the images.

The systems and methods remedy these deficiencies by supporting and facilitating a dynamic feed whereby images are consolidated within a designated area of the feed according to common parameters such as location, event data, and/or the like. As new images are uploaded by users, the systems and methods will update the feed to include the new images in appropriate areas based on the applicable common parameter. Accordingly, users are able to easily and efficiently ascertain which events or locations where certain friends or contacts may be, as well as view images in an organized layout. Further, the ability for the systems and methods to dynamically update the feed reduces the need for users to scroll through less desirable content in an effort to view images or content associated with a desired location or event.

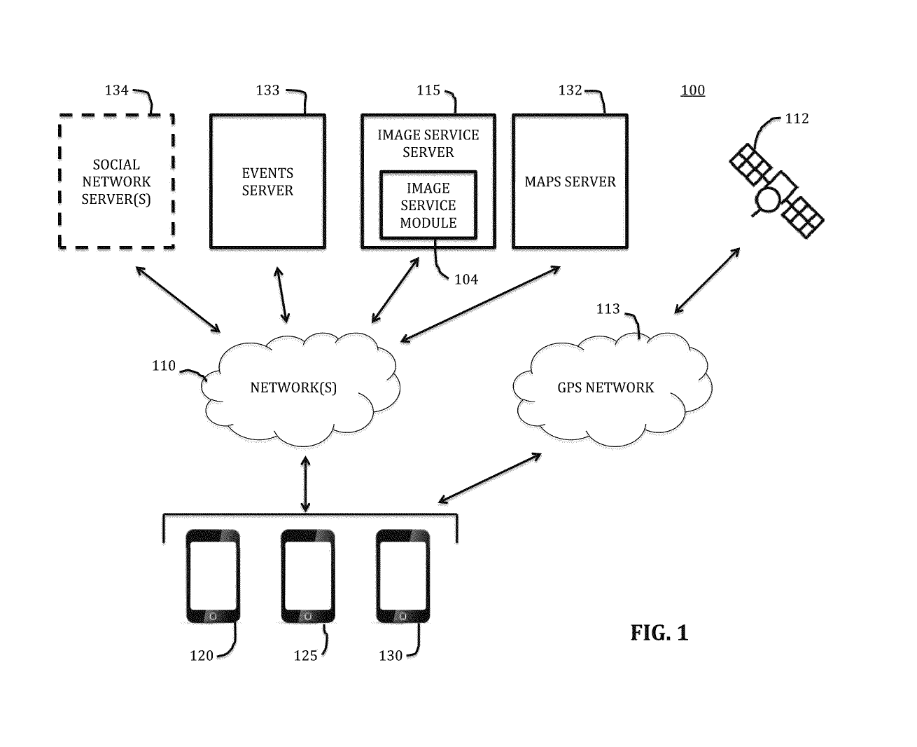

FIG. 1 depicts an environment 100 including various components and entities configured to facilitate the functionalities as described herein. It should be appreciated that the environment 100 is merely an example and can include fewer or more components and entities, as well as other various combinations of components and entities.

As shown in FIG. 1, the environment 100 includes electronic devices 120, 125, 130 configured for use by respective users. Although three electronic devices are shown in FIG. 1, it should be appreciated that other amounts of electronic devices are envisioned. It should be understood that the electronic devices 120, 125, 130 can be any type of device such as, for example, a mobile phone such as a smart phone, a notebook or desktop computer, a tablet device, a personal data assistant (PDA), a gaming device or the like, comprising any type of hardware or software components, or combinations thereof. Users can interface with the electronic devices 120, 125, 130 and/or applications thereof to facilitate and manage various functionalities associated with the components of the environment 100.

The environment 100 further includes an image service server 115, an events server 133, and a maps server 132. It should be appreciated that the image service 115, the events server 133, and the maps server 132 can be separate servers (as shown in FIG. 1) or combined into a single server. More particularly, a single server can include all of the components necessary to implement the embodiments as described herein. Further, each of the image service server 115, the events server 133, and the maps server 132 can have associated storage configured to store any applicable data.

The electronic devices 120, 125, 130 can connect to and communicate with any of the image service server 115, the events server 133, and the maps server 132 via one or more networks 110 such as, for example, a wide area network (WAN), a local area network (LAN), a personal area network (PAN) (e.g. a Bluetooth® or a near field communication (NFC) network), or other networks. The network 110 can facilitate any type of wireless data communication via any standard or technology (e.g., GSM, CDMA, TDMA, WCDMA, LTE, EDGE, OFDM, GPRS, EV-DO, WiMAX, WiFi, Bluetooth, UWB, and others). It should be appreciated that each of the image service server 115, the events server 133, and the maps server 132 can connect to and communicate with each other, for example via the network 110. Similarly, each of the electronic devices 120, 125, 130 can connect to and communicate with each other, for example via the network 110.

The components of the environment 100 can implement the systems and methods that facilitate and manage the image association functionalities. According to embodiments, the image service server 115 can include an image service module 104 configured to implement an image service capable of implementing the embodiments as discussed herein. The electronic devices 120, 125, 130 can be associated with each other via the image service. More particularly, the users of the electronic devices 120, 125, 130 can register for an account, a registration, a profile, or the like with the image service. According to embodiments, each user of the image service (such as the users of the electronic devices 120, 125, 130) can have an associated profile that can include any type of profile data. Further, each of the electronic devices 120, 125, 130 can be configured to execute an application (such as an image service application) that can interface with the image service module 104 and the associated image service to facilitate the functions as described herein. The users of the electronic devices 120, 125, 130 can use the corresponding applications to register with the image service, create profiles, upload images, connect with other users, and perform other functions associated with the image service.

The users of the electronic devices 120, 125, 130 can be “connected” to or “following” each other or otherwise members of a common group via a social feature of the image service. For example, an account of the user associated with the electronic device 125 can be connected to or otherwise associated with an account of the user associated with the electronic device 130. In some cases, some of the “connections” within the image service can be mutual whereby if User A is connected to User B, then User B is connected to User A. In other cases, some of the connections can be one-directional whereby if User A is following User B within the image service, then User B is not necessarily following User A. The social feature can enable users to share images with each other, such as a particular user sharing an image with one or more connections or followers. For example, if a first user captures and shares an image, any additional user who is connect to or following the first user can use the application of the corresponding electronic device to view or otherwise access the image. In embodiments, one or more users can belong to a certain group or other type of aggregation of users. It should be appreciated that other types of connections, followings, and groups functionalities among users are envisioned.

The events server 133 can include any combination of hardware and software, and can be configured to store information and data related to various events. For example, the events can be sporting events, concerts, fundraisers, scheduled gatherings (e.g., birthday parties), and the like; and the information can include associated venues, times, dates, and/or the like. For example, data for a specific sporting event can include a venue, a date, a start time, an end time, and/or other information. In some cases, the data can include a listing of users who may have indicated that they intend to attend the event. It should be appreciated that the event data can include additional information.

The maps server 132 can include any combination or hardware and software, and can be configured to store information and data related to various locations, such as venues (e.g., restaurants, bars, buildings, sports venues), landmarks, parks, natural resources, and others (hereinafter referred to as “location objects”). In embodiments, the location data can include GPS coordinates outlining the boundaries or perimeter of a certain location object. For example, the maps server 132 can store GPS coordinates corresponding to the boundaries or perimeter of Lake Michigan. For further example, the maps server 132 can store GPS coordinates corresponding to a certain restaurant. It should be appreciated that other location data conventions and types are envisioned.

Users of the respective electronic devices 120, 125, 130 can interface with the respective electronic devices 120, 125, 130 to initiate an image service application and manage the functionalities as discussed herein. According to embodiments, each of the electronic devices 120, 125, 130 can be configured to capture an image and generate corresponding image data via an imaging sensor such as a camera. Further, each of the electronic devices 120, 125, 130 can identify its location and append corresponding location data to the image data. In embodiments as shown in FIG. 1, each of the electronic devices 120, 125, 130 can connect to a GPS satellite 112 via a global positioning system (GPS) network 113, receive its corresponding GPS coordinates, and append the GPS coordinates to the image data as metadata. For example, if the electronic device 120 is located in a certain park and captures an image and generates corresponding image data, the electronic device 120 can determine its GPS coordinates (i.e., those corresponding to the park), and append the GPS coordinates to the image data as metadata. It should be appreciated that other location determination techniques are envisioned, such as via cellular triangulation, via connections to other networks, or via other techniques. Further, it should be appreciated that the respective electronic devices 120, 125, 130 can determine or identify locations automatically using location determination techniques or via user input from a user interfacing with the respective electronic devices 120, 125, 130.

As shown in FIG. 1, the environment 100 can further include optional social network servers 134 to which the image service server 115 can connect, such as via the networks 110. According to embodiments, the social network servers 134 can store data corresponding to various social network services such as, for example, Facebook, Instragram, Flickr, Google, Tumblr, Twitter, Dropbox, Live, Photobucket, Shutterfly, and others. Further, the users of one or more of the electronic devices 120, 125, 130 can have accounts or profiles with any of the social networks associated with the social network servers 134. In operation, the image service server 115 can interface with the social network servers 134 to retrieve image data that is uploaded by users, or otherwise stored by the social network servers 134. According to embodiments, the image data can include metadata that indicates a location of the image (e.g., GPS coordinates) and time data of the image (e.g., a timestamp). Further, according to some embodiments, the image service server 115 can interface with the social network servers 134 via associated application programming interfaces (APIs).

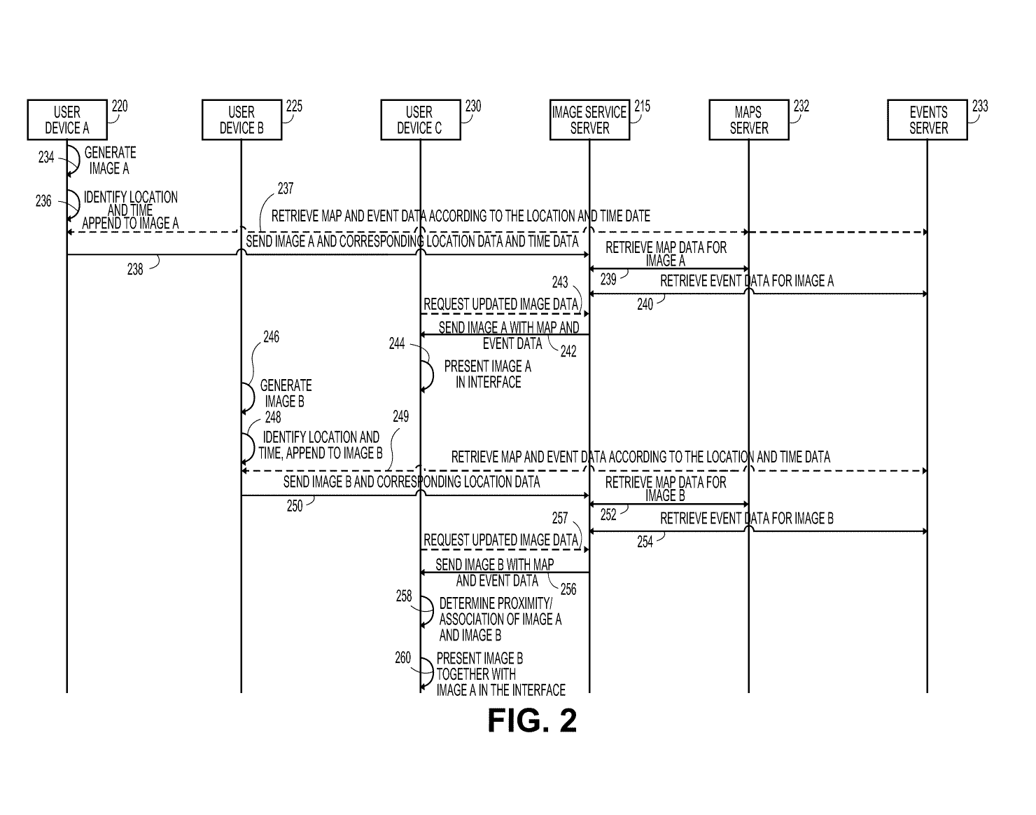

FIG. 2 depicts an exemplary flow chart 200 illustrating the various functionalities of various embodiments as discussed herein. The flow chart 200 includes device A 220, device B 225, device C 230 (such as the electronic devices 120, 125, 130 as described with respect to FIG. 1), and an image service server 215 (such as the image service server 115 as described with respect to FIG. 1). The chart 200 further includes a maps server 232 (such as the maps server 132 as described with respect to FIG. 1) and an events server 233 (such as the events server 133 as described with respect to FIG. 1). The maps server 232 can store information related to locations of landmarks; venues such as restaurants, bars, concert venues, and the like; roadways; other locations such as lakes, rivers, parks; and/or the like; and the events server 233 can store information related to scheduled events such as, for example, concerts, sporting events, fundraisers, parties, gatherings, and/or other events. In some embodiments, two or more of the image service server 215, the maps server 232, and the events server 233 can be combined into the same server.

According to embodiments, there are users associated with each device, where the users utilize the devices to facilitate the operations as shown. In aspects, users associated with device A 220, device B 225, and device C 230 can be connected to each other or following each other within a social network. Although FIG. 2 details the functionalities associated with images, it should be appreciated that other media data is envisioned, such as videos, audio clips, and the like.

Referring to FIG. 2, device A 220 can generate (234) image A using an imaging application and any corresponding hardware (e.g., an imaging sensor such as a camera). Device A 220 can further identify (236) its location and the current time and append the corresponding location data and time data to image A (e.g., as metadata). In embodiments, the corresponding location data can be GPS coordinates and the time data can be a timestamp. In some cases, device A 220 can retrieve (237) map and/or event data respectively from the maps server 232 and the events server 233, according to the location and time data. According to certain aspects, the map data can identify an associated landmark, building, venue, or the like (“location objects”); and the event data can indicate one or more associated concerts, sporting events, fundraisers, parties, gatherings, and/or another events, as well as the associated times and dates of the events. In these aspects, device A 220 can send its identified location data and time data to the maps server 232 and/or the events server 233 such that the maps server 232 and the events server 233 can identify relevant location objects and/or events, and return the location objects and events to device A 220. Further, device A 220 can reconcile its identified location data and time data with the map and/or event data to identify nearby or relevant location objects and/or events.

In embodiments, device A 220 can present various of the map data and/or the event data to the user such that the user can select the appropriate location object and/or event. For example, if the identified GPS coordinates correspond to a music venue, and the event data (1) indicates a scheduled concert at that music venue and (2) corresponds to the timestamp of the image, device A 220 can present the scheduled concert in a menu for the user to select. In embodiments, device A 220 can present other possibilities for a location object or event, such as if the other possibilities closely approximate the associated location and time data. For further example, device A 220 can determine that the identified GPS coordinates correspond to a park identified in the map data, and device A 220 can present an indication of the park in a menu for the user to select, in addition to optional additional possibilities for location objects.

Device A 220 can send (238) image A and any corresponding timestamp, location data, selected location object, and selected event data to the image service server 215. In some cases, device A 220 can send only image A and the identified location data (e.g., GPS coordinates) and time data (e.g., timestamp). In other cases, device A 220 can send image A along with the location data, time data, and any location objects or events that the user selects. Referring back to the above examples, device A 220 can send image A, a timestamp, and an indication of the concert that is selected by the user of device A 220; or device A 220 can send image A and an indication of the park. In certain aspects, the image service server 215 can modify the received data, such as by appending an identification of the sending user (here: the user corresponding to device A 220).

In some implementations, the image service server 215 can retrieve (239) map data for image A from the maps server 232 and can retrieve (240) event data for image A from the events server 233. Particularly, the image service server 215 can send the location data and timestamp data associated with image A to the respective servers 232, 233 such that the respective servers 232, 233 send relevant results to the image service server 215. In these implementations, the image service server 215 can automatically and intelligently select a most relevant location object or event from the retrieved data. For example, if the location data of image A corresponds to Soldier Field (as compared to data retrieved from the maps server 232), and the event data from the events server 233 indicates a Bears game being played at Soldier Field (and the associated timestamp of image A coincides with the scheduled event time of the Bears game), then the image service server 215 can determine that image A was taken at or is otherwise associated with the Bears game. Accordingly, the image service server 215 can append, to image A (e.g., as metadata), data indicating that image A is associated with the Bears game.

The image service server 215 can send (242) image A and corresponding map and/or event data to device C 230. Particularly, the image service server 215 can send the original location and time data corresponding to image A, or any location object or event that the image service server 215 identifies or determines. In some cases, the image service server 215 can send image A and corresponding map and/or event data automatically. In other cases, the server 215 can send image A and corresponding map and/or event data in response to receiving (243) a request from device C 230, such as if device C 230 initiates an application that requests retrieval of updated data associated with a user account of the application. For example, if a user of device C 230 is connected to a user of device A 220 within a social network feature of the images service server 215, and device C 230 initiates or “refreshes” a corresponding social network application, the social network application can request a retrieval of updated media data and corresponding map and/or event data from the image service server 215. Upon receipt of the request, the image service server 215 can provide the updated data, including image A that originates from device A 220 and any location object or event associations of image A.

Device C 230 can present (244), in an interface, image A, along with an indication of the originating user (here: the user associated with device A 220). Further, device C 230 can indicate, in the interface, the timestamp of image A and the corresponding location object and/or event associated with image A. According to embodiments, device C 230 can enable a user to select various of the displayed information. For example, if the user selects the indication of the user of device A 220, device C 230 can display a profile associated with the user of device A 220 along with the associated profile information. For further example, if the user selects the timestamp corresponding to image A, device C 230 can display a map that indicates a graphical representation of the corresponding location object or event (along with a list of other users who also have images associated with the location object or event).

Device B 225 can generate (246) image B using an imaging application and any corresponding hardware (e.g., an imaging sensor such as a camera). According to embodiments, device B 225 can generate image B prior to, concurrent with, or subsequent to the other processing steps (234, 236, 238, 240, 242, 244) explained herein. Device B 225 can further identify (248) its location and the current time and append the corresponding location data and time data to image B (e.g., as metadata). In embodiments, the corresponding location data can be GPS coordinates and the time data can be a timestamp. In some cases, device B 225 can retrieve (249) map and/or event data respectively from the maps server 232 and the events server 233 according to the location and time data. According to certain aspects, the map data can identify an associated landmark, building, venue, or the like (“location objects”); and the event data can indicate one or more associated concerts, sporting events, fundraisers, parties, gatherings, and/or another events, as well as the associated times and dates of the events. In these aspects, device B 225 can send its identified location data and time data to the maps server 232 and/or the events server 233 such that the maps server 232 and the events server 233 can identify relevant location objects and/or events and return the location objects and events to device B 225. Further, device B 225 can reconcile its identified location data and time data with the map and/or event data to identify nearby or relevant location objects and/or events.

In embodiments, device B 225 can present various of the map data and/or the event data to the user such that the user can select the appropriate location object and/or event. For example, if the identified GPS coordinates correspond to a music venue, and the event data (1) indicates a scheduled concert at that music venue and (2) corresponds to the timestamp of the image, device B 225 can present the scheduled concert in a menu for the user to select. In embodiments, device B 225 can present other possibilities for a location object or event, such as if the other possibilities closely approximate the associated location and time data. For further example, device B 225 can determine that the identified GPS coordinates correspond to a park identified in the map data, and device B 225 can present an indication of the park in a menu for the user to select, in addition to optional additional possibilities for location objects.

Device B 225 can send (250) image A and any corresponding timestamp, location data, selected location object, and selected event data to the image service server 215. In some cases, device B 225 can send only image B and the identified location data (e.g., GPS coordinates) and time data (e.g., timestamp). In other cases, device B 225 can send image B along with the location data, time data, and any location objects or events that the user selects. Referring back to the above examples, device B 225 can send image B, a timestamp, and an indication of the concert that is selected by the user of device B 225; or device B 225 can send image B and an indication of the park. In certain aspects, the image service server 215 can modify the received data, such as by appending an identification of the sending user (here: the user corresponding to device B 225).

In some implementations, the image service server 215 can retrieve (252) map data for image B from the maps server 232 and can retrieve (252) event data for image B from the events server 233. Particularly, the image service server 215 can send the location data and timestamp data associated with image B to the respective servers 232, 233 such that the respective servers 232, 233 send relevant results to the image service server 215. In these implementations, the image service server 215 can automatically and intelligently select a most relevant location object or event from the retrieved data. For example, if the location data of image B corresponds to Soldier Field (as compared to data retrieved from the maps server 232), and the event data from the events server 233 indicates a Bears game being played at Soldier Field (and the associated timestamp of image B coincides with the scheduled event time of the Bears game), then the image service server 215 can determine that image B was taken at or is otherwise associated with the Bears game. Accordingly, the image service server 215 can append, to image B (e.g., as metadata), data indicating that image B is associated with the Bears game.

The image service server 215 can send (256) image B and corresponding map and/or event data to device C 230. Particularly, the image service server 215 can send the original location and time data corresponding to image B, or any location object or event that the image service server 215 identifies or determines. In some cases, the image service server 215 can send image B and corresponding map and/or event data automatically. In other cases, the server 215 can send image B and corresponding map and/or event data in response to receiving (257) a request from device C 230, such as if device C 230 initiates an application that requests retrieval of updated data associated with a user account of the application. For example, if a user of device C 230 is connected to a user of device B 225 within a social network feature of the image service server 215, and device C 230 initiates or “refreshes” a corresponding social network application, the social network application can request a retrieval of updated media data and corresponding map and/or event data from the image service server 215. Upon receipt of the request, the image service server 215 can provide the updated data, including image B that originates from device B 225 and any location object or event associations of image B.

Device C 230 can determine (258) that the data of image A is associated with the data of image B. In some cases, device C 230 can determine that the location object of image A is equal to the location object of image B. For example, the respective location objects of image A and image B can both indicate a certain restaurant. For further example, device C 230 can analyze the raw location data to determine that the location data of image A closely approximates that of image B (and can identify an associated location object from the raw location data). In other cases, device C 230 can determine that the event data of image A is equal to that of image B. For example, the respective event data of image A and image B can both indicate an opera performance taking place at a certain venue at a certain time. In some embodiments, the image service server 215 can determine that the data of image A is associated with the data of image B, and can send an indication to device C 230 of the association (along with any associated location object or event).

In still further cases, device C 230 can analyze the metadata of respective image A and image B to determine that the metadata corresponds to a specific location object or event. In these cases, device C 230 can interface the maps server 232 and the events server 233 to retrieve relevant location object and events data related to the metadata of image A and image B. For example, device C 230 can determine that the GPS coordinates of image A are proximal to the GPS coordinates of image B, and further that the GPS coordinates coincide with a certain location object. For further example, device C 230 can determine that the timestamps of image A and image B overlap with the times of a certain event (and further that the GPS coordinates of image A and image B correspond to a venue of the event), and therefore that image A and image B are associated with the certain event.

Device C 230 can present (260) image B together with image A in the interface, along with an indication of the originating user (here: the user associated with device B 225). It should be appreciated that different arrangements of image A and image B are envisioned, such as side-by-side, in a scrolling interface, one image on top of another, or other arrangements. Further, device C 230 can indicate, in the interface, the timestamp of image B and the corresponding location object and/or event associated with image B. According to embodiments, device C 230 can enable a user to select various of the displayed information. For example, if the user selects the indication of the user of device B 225, device C 230 can display a profile associated with the user of device B 225 along with the associated profile information. For further example, if the user selects the timestamp corresponding to image B, device C 230 can display a map that indicates a graphical representation of the corresponding location object or event (along with a list of other users who also have images associated with the location object or event).

In embodiments, device C 230 can receive additional image data, such as an additional image (and associated metadata) from the image service server 215, can determine a common location object or event, and update the interface accordingly. For example, if a new image is received that has location data that corresponds to images already displayed in the interface, device C 230 can add the new image to the interface in a location or area along with the other images.

Although FIG. 2 depicts that various components of the environment 200 can perform the analyses as discussed herein, it should be appreciated that any of the components of the environment 200, such as user device A 220, user device B 225, user device C 230, or the image service server 215, can perform the analyses. Particularly, one analysis can include comparing location data and/or time data to map data and/or event data to determine a corresponding location object or event. A further analysis can include comparing location data of two images to determine that the respective location data is equal or approximately equal (and then identifying an associated location object corresponding to the location data). A still further analysis can include comparing location data and/or time data of an image to an identified location object or event to determine that the image is associated with the identified location object or event. It should be appreciated that other calculations and analysis associated with image metadata (e.g., location data and time data), map data from the maps server 232, event data from the events server 233, any identified location objects or events, and/or the like, are envisioned. Further, it should be appreciated that the image service server 215 can perform these analyses to generate an image data feed indicating any images as well as the ordering of the images, as well as “push” the image data feed including the arrangement of the images to any of device A 220, device B 225, or device C 230, whereby respective device A 220, device B 225, or device C 230 is configured to display the feed content via a user interface.

It should be appreciated that any of device A 220, device B 225, device C 230, and the image service server 215 can interface with the maps server 232 and/or the events server 233 to request and receive respective location and event data. Further, it should be appreciated that any of device A 220, device B 225, device C 230, and the image service server 215 can reconcile the location and event data with metadata of one or more images to (1) determine associated location objects or events and (2) determine consistencies, approximations, matches, or similarities between or among the associated location objects and events. Further, although the present embodiments are described as determining location objects and events associated with images, it should be appreciated that the systems and methods can perform similar calculations and techniques for other data such as videos, text messages, e-mails, and/or the like.

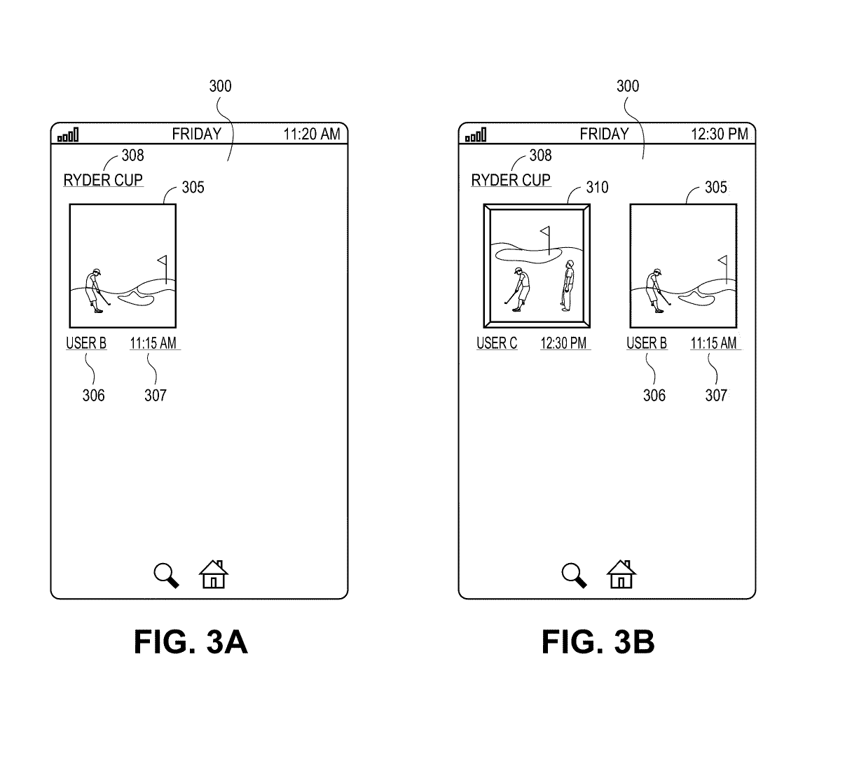

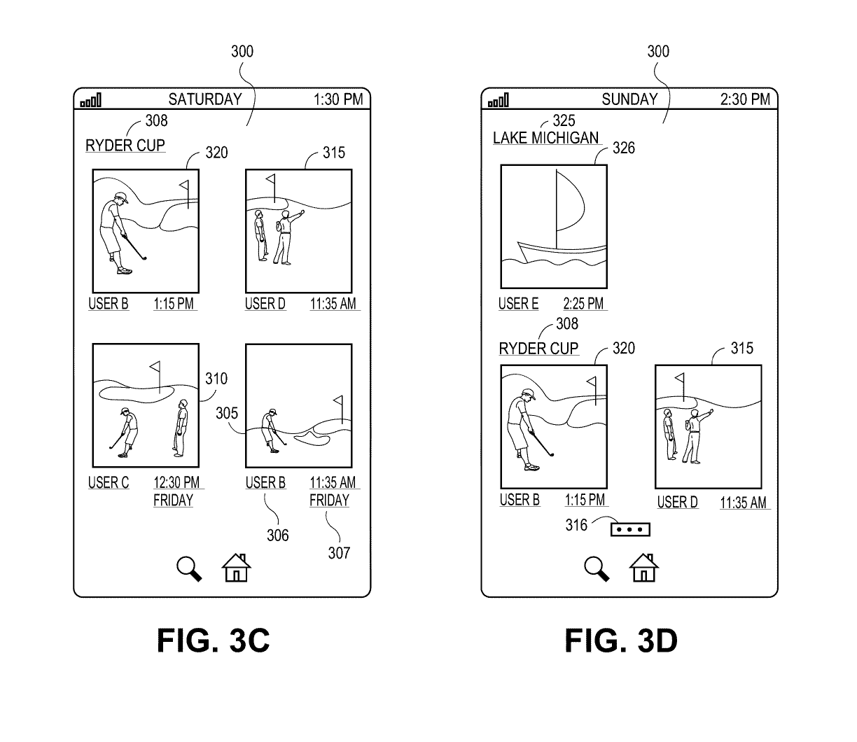

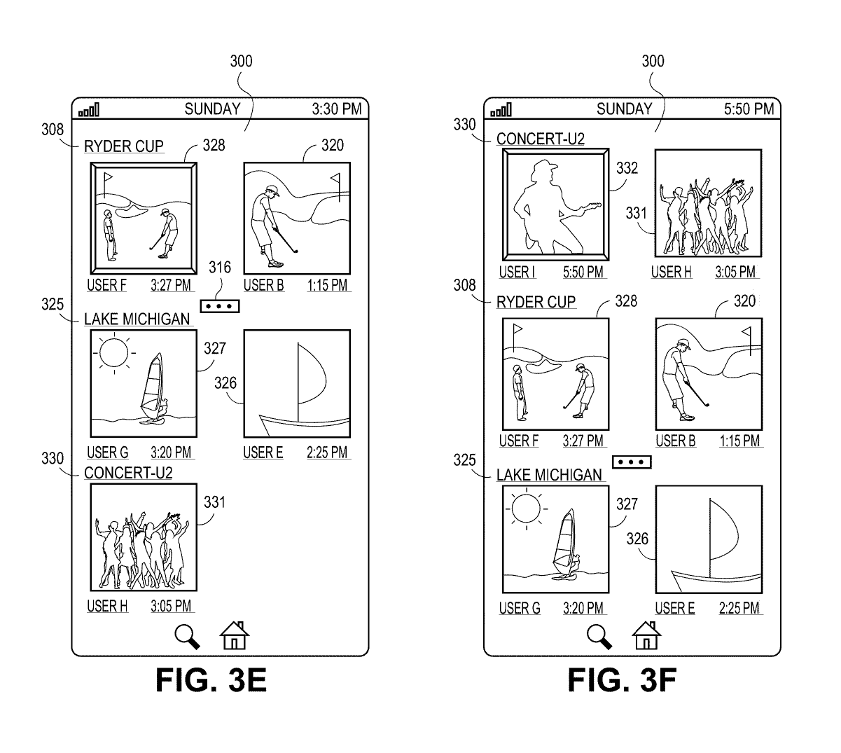

Referring to FIGS. 3A-3F, 4A, 4B, 5A, and 5B, depicted are exemplary interfaces capable of being displayed on an electronic device and illustrating the present embodiments. In embodiments, any of the electronic devices 120, 125, 130 can execute a corresponding image service application that can be configured to display the interfaces. It should be appreciated that the interfaces and displayed components thereof are exemplary and can include other various components and combinations of components. For purposes of explanation, it should be appreciated that the exemplary interfaces are associated with a device of exemplary User A.

Referring to FIG. 3A, an interface 300 includes an image 305 with an associated location indication 308, user indication 306, and time indication 307. According to embodiments, the location indication 306 can indicate or approximate the location associated with the location metadata of the image 305. In embodiments, the location indication 308 can indicate a location object identified by any electronic device or server component, such as the image service server. As shown in FIG. 3, the location indication 308 indicates the Ryder Cup. Further, the user indication 306 indicates a user who originally captured and/or uploaded the image 305 to an image service server, and the time indication 307 indicates the time at which the user of the user indication 306 captured and/or uploaded the image 305 to the image service server. For example, in the interface 300 as shown, user B captured (or uploaded) the image 305 to the image service server at 11:15 AM.

According to some embodiments, the device corresponding to user B compared the metadata of the image 305 to corresponding map data and event data from respective databases to determine the location indication 308 (Ryder Cup). In other embodiments, the image service server compared the metadata of the image 305 to corresponding map data and event data from respective databases to determine the location indication 308. In still further embodiments, the device of user A compared the metadata of the image 305 to corresponding map data and event data from respective databases to determine the location indication 308. In aspects, the map data can indicate associated boundary or perimeter coordinates for the Ryder Cup, such as the perimeter coordinates associated with a golf course, and the device can determine that the location metadata of the image 305 (e.g., GPS coordinates) is within the within coordinates. In some cases, any device or server component can analyze corresponding event data with the location metadata and the map data to determine that (1) the image 305 was taken at a particular golf course, and (2) the image was taken during an event that was being played at the golf course on a particular data that the event was scheduled. In cases in which the device of User A performs the analyzing, the device can determine the Ryder Cup indication and display “Ryder Cup” as the location indication 308 even though user B may not have explicitly selected the Ryder Cup when capturing or uploading the image.

Referring to FIG. 3B, depicted is the interface 300 that is updated with a new image captured and uploaded by an additional user. In particular, as shown in FIG. 3B, user C captured and/or uploaded an image 310 at 12:30 PM. The device can highlight the image 310 in the interface 300 to indicate that the image was recently added to the interface 300, that the image 310 is the newest image displayed in the interface 300, or for other reasons. According to embodiments, the device of User A can analyze the metadata of the image 310 and any corresponding map data and event data, determine that the image was taken at the Ryder Cup, and determine that the location indication of image 310 matches that of image 305. In some cases, the device of User A can receive the location indication for image 310 and determine that the location indication matches that of the image 305. Continuing with the example, the device of User A can determine that the image 310 has GPS coordinates that are located within the boundaries of the golf course at which the Ryder Cup is being played, and has a timestamp that matches the scheduled time for the Ryder Cup. In response to determining that the location indication of the image 310 matches or approximates that of the image 305, the device of User A can update the interface 300 by consolidating or compiling the image 310 and the image 305 within the same area or location of the interface 300. Particularly, the device of User A can display both images 305, 310 in the section corresponding to the Ryder Cup location indication 308. According to embodiments, the device of User A can organize or consolidate the images 305, 310 according to other conventions such that it is apparent to User A that the images 305, 310 are in some way associated.

Referring to FIG. 3C, depicted is the interface 300 that is updated with new images captured and uploaded by additional users. As shown in FIG. 3C, the interface 300 is updated on a day (Saturday) that is subsequent to the day (Friday) as depicted in FIGS. 3A and 3B. According to the example, the Ryder Cup can be scheduled for multiple days (e.g., Thursday through Sunday). In embodiments, the device of User A can retrieve, access, or maintain a calendar or event listing to determine the schedule of the corresponding to events. As shown in FIG. 3C, User D captured and/or uploaded an image 315 at 11:35 AM on Saturday and User B captured and/or uploaded an image 320 at 1:15 PM on Saturday. The device can update, in the interface 300, the time indications of the images 305, 310 to reflect that they were captured and/or uploaded on Friday. According to some embodiments, the device of user A can update the interface 300 by receiving the images 315, 320 from a server, analyzing the location metadata of the images 315, 320, and updating the interface 300 by displaying all of the images 305, 310, 315, 320 in the same section or location of the interface 300. In other embodiments, the device of User A can receive location indications (e.g., a location object or a specified event), determine that the location indications are the same, and display the corresponding images in the same area or section of the interface 300.

Referring to FIG. 3D, depicted is the interface 300 that is updated with images associated with a new event or location. In particular, the interface 300 of FIG. 3D includes the Ryder Cup location indication 308 and the corresponding images from the Ryder Cup (320, 315). Additionally, the interface 300 of FIG. 3D includes a new image 326 as well as a new location indication 325. According to embodiments, the device of User A can receive the image 326 and analyze location metadata (e.g., GPS coordinates, determined location object, etc.) associated with the image 326. Based on the analysis, the device of User A can determine that the location metadata corresponds to Lake Michigan (and is therefore different from the associated Ryder Cup location indication 308). Accordingly, the device of User A can update the interface 300 with the image 326 along with the Lake Michigan location indication 325. As shown in FIG. 3D, the device of User A can display the image 326 near the top of the interface 300 and can move or redisplay the Ryder Cup images (320, 315) towards the bottom of the interface 300. Accordingly, the device of User A can display the most recent image (image 326, which the device of User E captured or uploaded at 2:25 PM), at the top of the interface 300. Further, the interface 300 can include a select more option 316, whereby in response to a user selecting the select more option 316, the device of User A can display any additional images that are associated with that particular location indication (in this case: the other images 305, 310 from the Ryder Cup).

Referring to FIG. 3E, depicted is the interface 300 that is updated with images associated with a new event or location as well as a previously-identified event(s) or location(s). In particular, the interface 300 of FIG. 3E includes the location indication 325 for Lake Michigan along with the image 326 as discussed with respect to FIG. 3D and the location indication 308 for the Ryder Cup along with the image 320 as discussed with respect to FIGS. 3C and 3D. Further, the device of User A has updated the interface 300 with an additional image 327 corresponding to Lake Michigan. Additionally, the electronic device can receive an image 331 and analyze location data of the image 331 to determine that the image 331 is associated with a U2 concert. Accordingly, the device of User A can update the interface 300 with a new location indication 330 for the U2 concert as well as the corresponding image 331.

As further shown in FIG. 3E, the electronic device can receive an additional image 328 that is associated with the Ryder Cup. Accordingly, the device of User A can update the interface 300 by displaying the additional image 328 at the top of the interface 300 because the additional image 328 is also the most recently captured or uploaded image. Indeed, a device of User F captured or uploaded the image 328 at 3:27 PM. Further, the device of User A can highlight the additional image 328 in the interface as shown in FIG. 3E. According to embodiments, the electronic device can arrange or group the images (328, 320, 327, 326, 331) within the interface according to (1) the associated event or location (i.e., by grouping the images according to the location indications) and (2) the time at which the associated devices captured or uploaded the images.

Referring to FIG. 3F, depicted is the interface 300 that is updated with a new image associated with a previously-identified event or location. In particular, the device of User A can receive a new image 332 and analyze the location data of the image 332 to determine that the image 332 is associated with the U2 concert. Accordingly, the device of User A can update the interface 300 to display the image 332 within the section corresponding to the location indication 330 for the U2 concert. In this way, because the image 332 is the most recently captured or uploaded image, the device of User A can update the interface 300 to include the location indication 330 for the U2 concert and its associated images (332, 331) near the top of the interface 300, and correspondingly move or redisplay the other location indications 308, 325 and images thereof down in the interface 300. It should be appreciated that other moving or redisplaying techniques are envisioned.

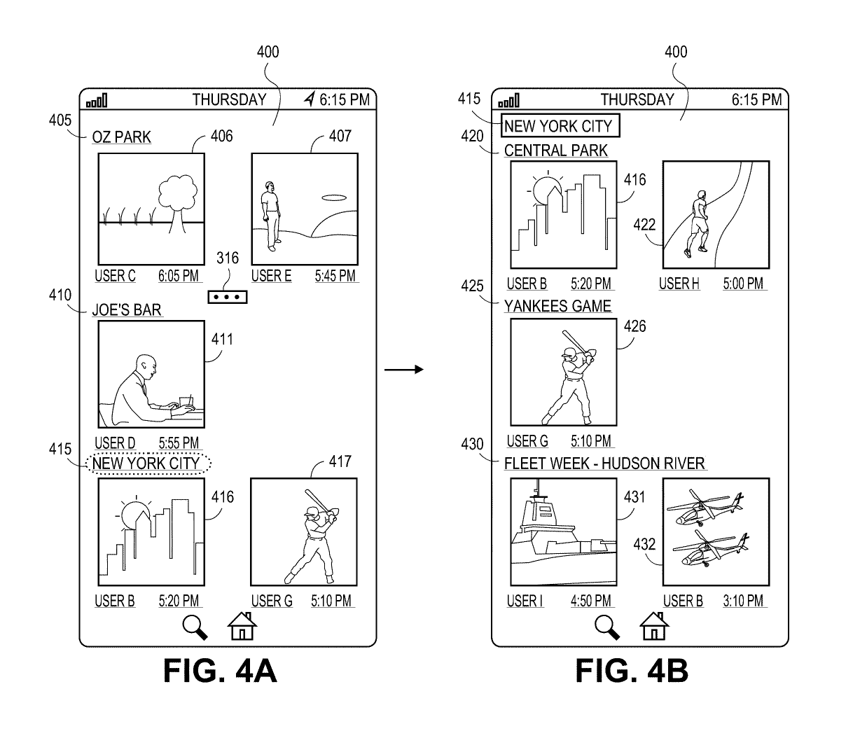

Referring to FIG. 4A, depicted is an interface 400 illustrating various functionalities of the systems and methods. In some cases, the user may be familiar with his or her home or default location but may not be familiar with a location that is a certain distance away from the home or default location. For example, if the user is from San Francisco, the user may not be familiar with location objects or events in Denver. Accordingly, it may be beneficial for the device to group or consolidate images associated with a specific region that is located a certain distance away from a home or default location associated with the user or the electronic device, even though the images may have different location indications within the specific region.

According to embodiments, the device can determine its location and compare its location to the location(s) of the images and location indications thereof included in the interface 400. If the difference in locations meets or exceeds a certain threshold, the device can group or consolidate the images into the same region of the interface 400 even though the location data of the images may be associated with different events or location objects. For example, if the home or default location of the device is in Chicago, the device can group or consolidate images that are captured in New York City even though the images may not be associated with the same event or location object (e.g., if one image is from a concert in New York City and one image is from a specific restaurant in New York City).

As shown in FIG. 4A, the interface 400 includes a series of location indications 405, 410, 415. Particularly, location indication 405 corresponds to Oz Park in Chicago and displays images 406, 407 with location data associated with Oz Park; location indication 410 corresponds to Joe's Bar in Chicago and displays an image 411 with location data associated with Joe's Bar; and location indication 415 corresponds to New York City and displays images 416, 417 with location data associated with location objects or events in New York City. The interface 400 also displays indications of which users captured and/or uploaded the images as well as the associated times (e.g., User B captured and/or uploaded image 416 on Thursday at 5:20 PM). According to embodiments, the device enables a user to select a location indication corresponding to consolidated images of different events or location objects (e.g., the location indication 415) and, in response to a user selection, the device displays an “expanded” view of the different events or location objects corresponding to the location indication.

Referring to FIG. 4B, the interface 400 displays images associated with the location indication 415 of New York City. In particular, the device can display the interface 400 as shown in FIG. 4B in response to detecting a selection of the location indication 415 as shown in FIG. 4A, thereby providing an “expanded” view of the different events or location objects associated with New York City. As shown in FIG. 4B, the interface 400 displays a location indication 420 and images 421, 422 associated with Central Park; a location indication 425 and an image 425 associated with the Yankees game, and a location indication 430 and images 431, 432 associated with Fleet Week on the Hudson River. Further, the device can arrange or order the images according to (1) the associated event or location object specified by the corresponding location indication as well as (2) the time when the corresponding user captured or uploaded the corresponding image.

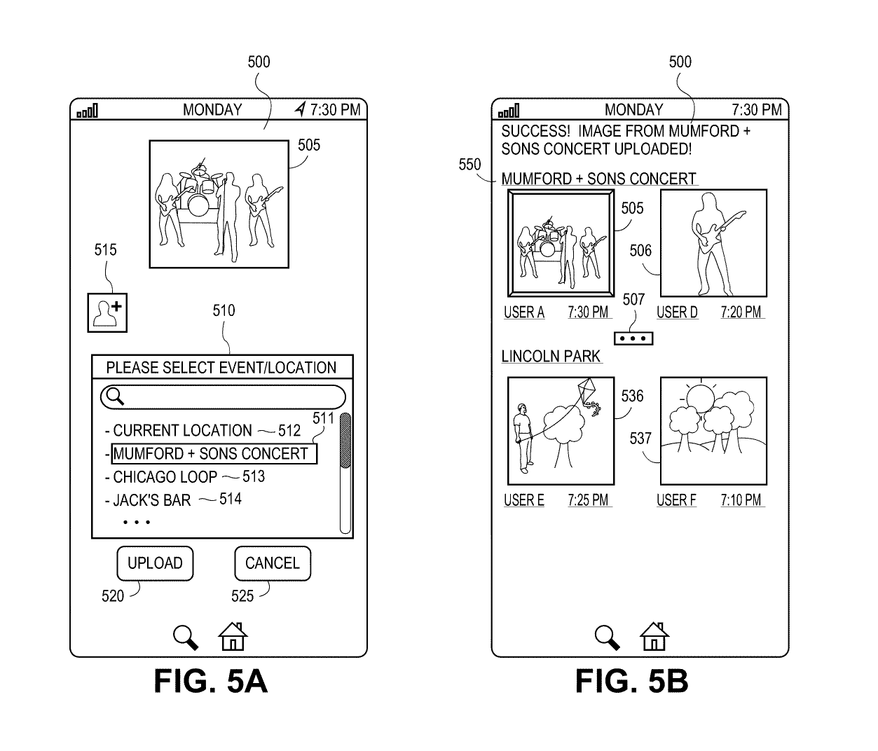

According to embodiments, the device can provide an interface that enables the user to capture an image using the device, optionally enables the user to select an associated event or location object for the image, and enables the user to upload the image to the corresponding social network. Referring to FIG. 5A, depicted is an exemplary interface 500 depicting these embodiments. The interface 500 displays an image 505 that the device has captured using an imaging sensor (i.e., camera) of the device. It should be appreciated that any corresponding imaging sensor application or interface can be used to capture the image 505.

The interface 500 can further include a menu 510 that enables the user to select an event or location object corresponding to the image 505. As shown in FIG. 5A, the menu 510 includes options for Mumford & Sons Concert (511), Chicago Loop (513), and Jack's Bar (514). The menu 510 further includes an option for current location (512). According to embodiments, if the user selects the current location option 512, the device can determine its current location (e.g., via identifying its GPS coordinates). In aspects, the device can populate the menu 510 by identifying its current location (e.g., via identifying its GPS coordinates) and then identifying any nearby events or location objects. The menu 510 further includes a search box 516 that enables the user to search for a nearby event or location object, such as in cases in which the event or location object is not included in the menu 510. In some embodiments, the user need not select an event or location from the menu 510. Instead, in these cases, the device can automatically identify its current location and append the location data as metadata associated with the image 505. The device can perform this functionality automatically in response to the device capturing the image 505.

As shown in FIG. 5A, the interface 500 further includes an upload option 520 and a cancel option 525. If the user selects the cancel option 525, the device can return to a previous interface, return to a camera application, or perform other functionalities. If the user selects the upload option 520, the device can upload the image 505 and the corresponding location metadata (e.g., GPS coordinates) to the server. In cases in which the user selects an event or location object from the menu 510 (such as the Mumford & Sons concert option 511 as shown in FIG. 5A), the device can append the associated data (such as an indication of the Mumford & Sons concert) as metadata to the image 505 and upload the image 505 and metadata to the server.

According to some embodiments, the interface 500 can further include a tagging option 515 that enables the user to select one or more additional users who are currently with the user or are otherwise associated with the image 505. When the user selects the upload option 520, the electronic device can also upload identifications of any additional users that the user selects via the tagging option 515.

Referring to FIG. 5B, depicted is the interface 500 that the device associated with User A can display after the device uploads an image (as shown: the image 505). The device can display, in the interface 500, an exemplary message 526 that indicates that an image has been uploaded (as shown: “SUCCESS! IMAGE FROM MUMFORD & SONS CONCERT UPLOADED!”). The interface 500 further includes a location indication 530 for the Mumford & Sons concert that displays the image 505 along with an additional image 506 also associated with the Mumford & Sons concert and already uploaded to the server. Particularly, the device of User A captured or uploaded the image 505 (which can be highlighted to indicate a recent upload as shown in FIG. 5A) at 7:30 PM and User D uploaded the image 506 at 7:20 PM. The interface 500 can also include a select more option 507 that indicates the existence of more images from the Mumford & Sons concert.

The interface 500 as depicted in FIG. 5B can also include an additional location indication 535 that indicates Lincoln Park along with images 536, 537 captured in or otherwise associated with Lincoln Park. The electronic device can order or arrange the location indications 530, 535 and the associated images 505, 506, 536, 537 according to embodiments as described herein.

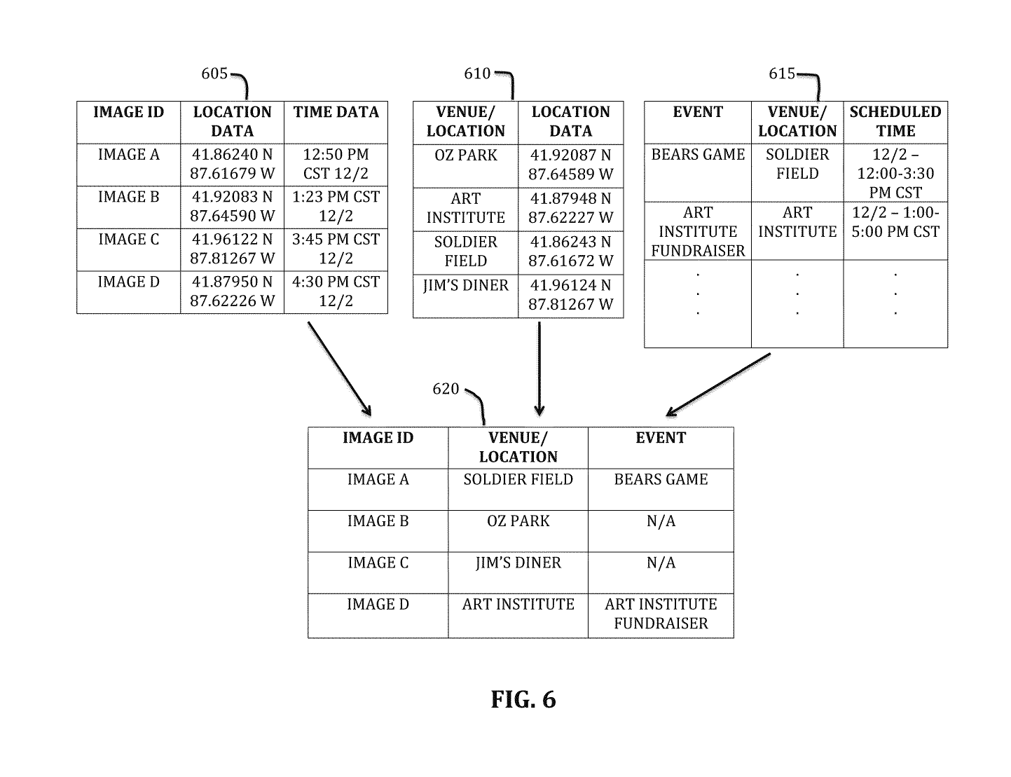

Referring to FIG. 6, depicted are exemplary charts that detail the embodiments as discussed herein. Particularly, FIG. 6 depicts an image chart 605, a location chart 610, an event chart 615, and a combination chart 620. It should be appreciated that the data of the charts 605, 610, 615, 620 is merely exemplary and can include other data or combinations of data.

According to embodiments, the image chart 605 includes columns for an image ID, location data, and time data. For example, Image A has location data (e.g., GPS coordinates) of 41.86240 N, 87.61679 W, and a capture time of 12:50 PM CST on December 2; Image B has location data of 41.92083 N, 87.64590 W, and a capture time of 1:23 PM CST on December 2; and so on. Further, the location chart 610 includes columns for venue/location and location data. For example, Oz Park has location data of 41.92087 N, 87.64589 W; the Art Institute has location data of 41.87948 N, 87.61672 W; and so on. As further shown in FIG. 6, the event chart 615 includes columns for event, venue/location, and scheduled time. For example, the Bears Game is scheduled at Soldier Field on December 2 from 12:00-3:30 PM CST; and the Art Institute Fundraiser is scheduled at the Art Institute on December 2 from 1:00-5:00 PM CST.

According to embodiments, a component such as any of the electronic devices 120, 125, 130 or the image service server 115 as discussed with respect to FIG. 1 can analyze the data of the charts 605, 610 615 to determine and populate the data of the combination chart 620. Particularly, the component can compare location data of the respective images of the image chart 605 to location data of the respective venues/locations of the location chart 610 to determine matches or approximations. For example, the location data of Image A closely approximates that of Soldier Field; therefore, the component can determine or estimate that Image A was taken at Soldier Field, as indicated in the combination chart 620.

The component can further reconcile the time data of the respective images of the image chart 605 with any identified venue/location with the data of the event chart 615. For example, the time data of Image D falls within the schedule time for the Art Institute Fundraiser and that the location data of Image D closely approximates that of the Art Institute; therefore, the component can determine or estimate that (1) Image D was taken at the Art Institute, and (2) Image D was taken during the Art Institute Fundraiser, as indicated in the combination chart 620.

FIG. 4 illustrates an example image service server 702 in which the embodiments may be implemented. The image service server 702 can include a combination of hardware and software components. Particularly, the image service server 702 includes a processor 730, a memory 732 (e.g., hard drives, flash memory, MicroSD cards, and others), and one or more external ports 722 (e.g., cellular input and output, Universal Serial Bus (USB), HDMI, Firewire, and/or others). The image service server 702 can further include a communication module 724 configured to interface with the one or more external ports 722 to communicate via one or more wired or wireless networks 710 such as, for example a WAN, LAN, PAN, and/or others. For example, the communication module 724 can include one or more transceivers (e.g., WWAN, WLAN, and/or WPAN transceivers) functioning in accordance with IEEE standards, 3GPP standards, or other standards, and configured to receive and transmit data via the one or more external ports 722. The components of the image service server 702 are capable of communicating with each other via a communication bus 734.

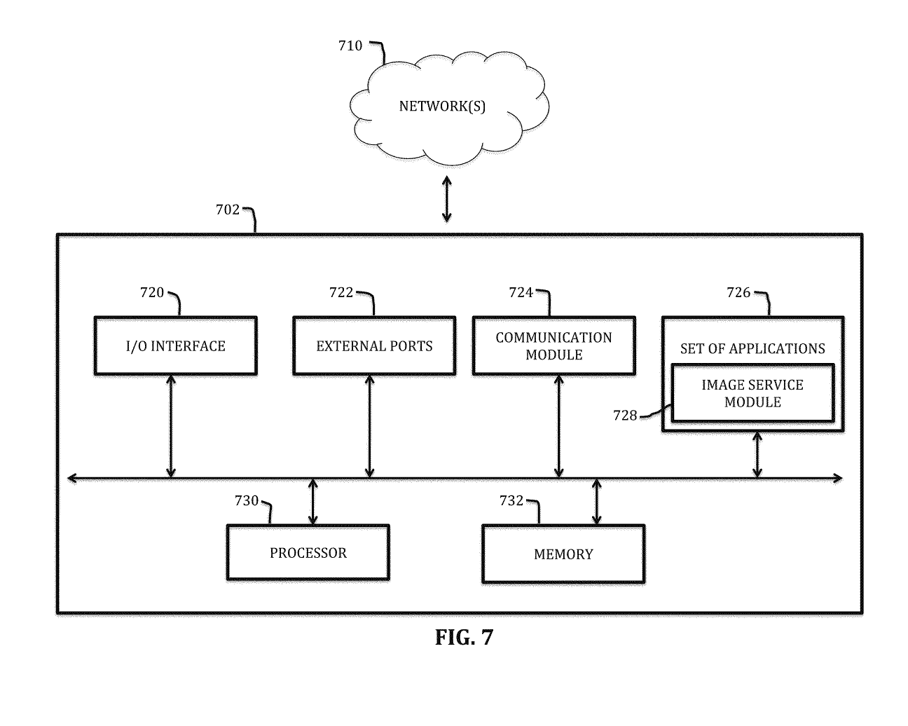

The image service server 702 can further include an input/output (I/O) interface 720 capable of communicating with one or more input devices and external displays (not shown in figures) associated with presenting information to a user or administrator and/or receiving inputs from the user or administrator. As shown in FIG. 7, the image service server 702 can further include a set of applications 726 that are configured to interface with other components of the image service server 702 to facilitate the functionalities of the systems and methods as described herein. Particularly, the set of applications 726 can include an image service module 728 that can be capable of receiving image data and associated image metadata from multiple electronic devices, interfacing with maps and events APIs, and consolidating the data to identify similarities, as discussed herein.

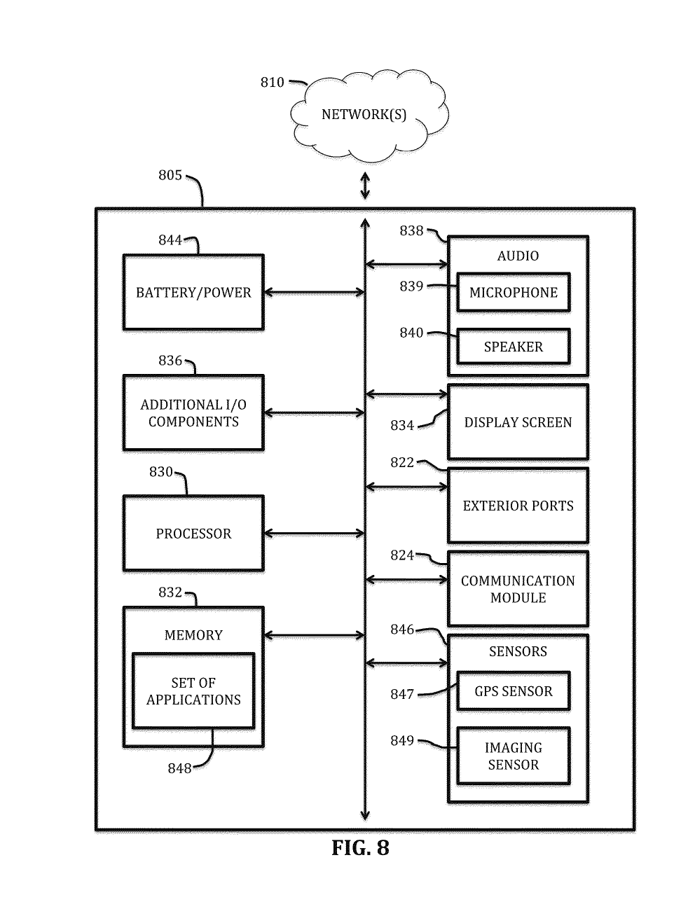

FIG. 8 illustrates an example electronic device 805 (such as user device C 230 as discussed with respect to FIG. 2) in which the aspects may be implemented. The electronic device 805 can include a processor 830, a memory 832 (e.g., hard drives, flash memory, MicroSD cards, and others), a power module 844 (e.g., batteries, wired or wireless charging circuits, etc.), and one or more external ports 822 (e.g., cellular input and output, Universal Serial Bus (USB), HDMI, Firewire, and/or others), each configured to communicate via a communication bus 823. The processor 830 can interface with the memory 832 to execute a set of applications 848 capable of facilitating the functionalities as discussed herein. For example, one of the applications can be an image service application configured to capture image data and upload the image data to a image service server.

The electronic device 805 can further include a communication module 824 configured to interface with the one or more external ports 822 to communicate data via one or more networks 810. For example, the communication module 824 can include one or more transceivers functioning in accordance with IEEE standards, 3GPP standards, or other standards, and configured to receive and transmit data via the one or more external ports 822. More particularly, the communication module 824 can include one or more WWAN transceivers configured to communicate with a wide area network including one or more cell sites or base stations to communicatively connect the electronic device 805 to additional devices or components. Further, the communication module 824 can include one or more WLAN and/or WPAN transceivers configured to connect the electronic device 805 to local area networks and/or personal area networks, such as a Bluetooth® network.

The electronic device 805 can further include one or more sensors 846 such as, for example, a GPS sensor 847, imaging sensors 849, and/or other sensors. The electronic device 805 can include an audio module 838 including hardware components such as a speaker 840 for outputting audio and a microphone 839 for receiving audio. The electronic device 805 may further include one or more display screen 834, and additional I/O components 836 (e.g., touch sensitive input, keys, buttons, lights, LEDs, cursor control devices, haptic devices, and others). The display screen 834 and the additional I/O components 836 may be considered to form portions of a user interface (e.g., portions of the electronic device 805 associated with presenting information to the user and/or receiving inputs from the user).

In embodiments, the display screen 834 is a touchscreen display using singular or combinations of display technologies such as electrophoretic displays, electronic paper, polyLED displays, OLED displays, AMOLED displays, liquid crystal displays, electrowetting displays, rotating ball displays, segmented displays, direct drive displays, passive-matrix displays, active-matrix displays, and/or others. Further, the display screen 834 can include a thin, transparent touch sensor component superimposed upon a display section that is viewable by a user. For example, such displays include capacitive displays, resistive displays, surface acoustic wave (SAW) displays, optical imaging displays, and the like.

In general, a computer program product in accordance with an embodiment includes a computer usable storage medium (e.g., standard random access memory (RAM), an optical disc, a universal serial bus (USB) drive, or the like) having computer-readable program code embodied therein, wherein the computer-readable program code is adapted to be executed by the processor 830 (e.g., working in connection with an operating system) to implement a user interface method as described below. In this regard, the program code may be implemented in any desired language, and may be implemented as machine code, assembly code, byte code, interpretable source code or the like (e.g., via C, C++, Java, Actionscript, Objective-C, Javascript, CSS, XML, and/or others).

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method in an electronic device of consolidating information, the method comprising:
receiving, from a server:
1) a first image associated with a first user, and
2) a second image associated with a second user;
identifying a first location object or event from the first image and a second location object or event from the second image;
determining, by a processor, that the first location object or event is associated with the second location object or event; and
responsive to the determining, presenting, in a common area of a user interface, the first image and the second image.

2. The method of claim 1, wherein the identifying comprises:
examining respective metadata of the first image and the second image to identify the first location object or event and the second location object or event.

3. The method of claim 1, wherein the determining comprises:
determining that the first location object or event is equal to the second location object or event.

4. The method of claim 1, wherein the presenting comprises:
relocating an existing image presented in the user interface; and
presenting the first image and the second image in the common area of the user interface, wherein the existing image previously occupied at least a portion of the common area.

5. The method of claim 4, wherein the existing image was captured prior to when the second image was captured and subsequent to when the first image was captured.

6. The method of claim 1, wherein the electronic device has a default location and wherein the method further comprises:
receiving a third image associated with a third user, the third image having a third location object or event that is different from the first location object or event and the second location object or event;
determining that the first location object or event, the second location object or event, and the third location object or event are associated with a location that is at least a predetermined distance away from the default location; and
presenting the third image in the common area with the first image and the second image, the common area indicating the location.

7. The method of claim 6, further comprising:
receiving, from a user via the user interface, a selection of the indication of the location; and
rearranging the user interface by presenting the first image and the second image in an additional common area of the user interface and presenting the third image separate from the first image and the second image.

8. The method of claim 1, wherein the presenting comprises presenting respective identifications of the first location object or event and the second location object or event adjacent to the respective first image and the second image.

9. A method in a network service device of consolidating image information, the method comprising:
receiving a first image associated with a first user and a second image associated with a second user;
identifying a first location object or event from the first image and a second location object or event from the second image;
determining, by a processor, that the first location object or event is associated with the second location object or event; and
generating, by a processor, an image data feed indicating the first image, the second image, and an association between the first location object or event and the second location object or event; and
transmitting, to a user electronic device, the image data feed for presentation on the user electronic device via a user interface.

10. The method of claim 9, wherein the identifying comprises:
examining respective metadata of the first image and the second image to identify the first location object or event and the second location object or event.

11. The method of claim 9, wherein the determining comprises:
determining that the first location object or event is equal to the second location object or event.

12. The method of claim 9, wherein the generating the image data feed comprises:
relocating an existing image within the image data feed; and
associating the first image with the second image within the image data feed according to the association between the first location object or event and the second location object or event.

13. The method of claim 12, wherein the existing image was captured prior to when the second image was captured and subsequent to when the first image was captured.

14. An electronic device comprising:
a user interface capable of presenting content;
a communication module;
a memory storing a set of instructions; and
a processor coupled to the user interface, the communication module, and the memory, the processor configured to execute the set of instructions to cause the processor to:
receive, from a server via the communication module:
1) a first image associated with a first user, and
2) a second image associated with a second user,
identify a first location object or event from the first image and a second location object or event from the second image,
determine that the first location object or event is associated with the second location object or event, and
responsive to the determination, cause the user interface to present the first image and the second image in a common area.

15. The electronic device of claim 14, wherein the processor identifies the first location object or event and the second location object or event by:
examining respective metadata of the first image and the second image to identify the first location object or event and the second location object or event.

16. The electronic device of claim 14, wherein the processor determines that the first location object or event is equal to the second location object or event.

17. The electronic device of claim 14, wherein the processor causes the user interface to present the first image and the second image in the common area by:
causing the user interface to relocate an existing image presented in the user interface, and
causing the user interface to present the first image and the second image in the common area, wherein the existing image previously occupied at least a portion of the common area.

18. The electronic device of claim 17, wherein the existing image was captured prior to when the second image was captured and subsequent to when the first image was captured.

19. The electronic device of claim 14, wherein the electronic device has a default location and wherein the processor is configured to execute the set of instructions to further cause the processor to:
receive, from the server via the communication module, a third image associated with a third user, the third image having a third location object or event that is different from the first location object or event and the second location object or event,
determine that the first location object or event, the second location object or event, and the third location object or event are associated with a location that is at least a predetermined distance away from the default location, and
cause the user interface to present the third image in the common area with the first image and the second image, the common area indicating the location.

20. The electronic device of claim 19, wherein the processor is configured to execute the set of instructions to further cause the processor to:
receive, from a user via the user interface, a selection of the indication of the location, and
cause the user interface to rearrange the first image and the second image in an additional common area and present the third image separate from the first image and the second image.
